(19) United States
(12) Patent Application Publication
(10) Pub. No.: US 2018/0375424 A1
(43) Pub. Date: Dec. 27, 2018

(54) SHORTING DEVICE FOR GROUNDING OF CONVERTER

(71) Applicant: HYOSUNG CORPORATION, Seoul (KR)

(72) Inventors: June Sung KIM, Anyang-si, Gyeonggi-do (KR); Hong Ju JUNG, Seoul (KR); Hyun Ho YOO, Seoul (KR)

(73) Assignee: HYOSUNG CORPORATION, Seoul (KR)

(21) Appl. No.: 16/062,371

(22) PCT Filed: Jun. 22, 2016
(86) PCT No.: PCT/KR2016/006634

§ 371 Date: Jun. 14, 2018

(30) Foreign Application Priority Data
Dec. 14, 2015 (KR) 10-2015-0178308

(51) Int. Cl. H02M 1/32; H02B 5/01; H01R 11/14

(52) U.S. Cl. CPC H02M 1/32; H01R 4/48; H01R 11/14; H02B 5/01

(57) ABSTRACT

A shorting device for facilitating the grounding of a converter to which a plurality of sub modules is connected in series. The device includes: a moving rod (40) provided on a main frame (10) on which sub modules (S) are provided, and moving in the direction traversing the sub modules (S); and contactors (50) provided at the moving rod (40) to be electrically connected to each sub module outer casing (1) according to the movement of the moving rod (40). In addition, a connection means (C) electrically connects the contactor (50), the sub module outer casing (1), and another adjacent sub module outer casing (1) to enable simultaneous grounding thereof. This invention connects the sub module outer casings (1), which form the converter, through the operation of the shorting device to ground the sub modules (S).

### TECHNICAL FIELD

The present invention relates to a shorting device for the grounding of a converter and, more particularly, to a shorting device that enables grounding by providing simultaneous connections between sub-modules in a modularized converter having a plurality of serially connected sub-modules.

### BACKGROUND ART

Recent times have seen ongoing technological developments in the field of power grid-connected systems. For instance, the grid-connected inverter in a solar power generation system converts the direct current power generated by photovoltaic module into alternating current power and connects to the grid, obviating the need for a storage battery. Such grid-connected systems, such as the HVDC (high voltage direct current) system, the STATCOM (static synchronous compensator) system, etc. are implemented with a modular multilevel converter (MMC), where the conventional modular multilevel converter includes a plurality of sub-modules that is connected in series, as well known in the art.

Such a converter device not only handles high voltage but also has a very large volume and is hence often installed in a separate valve chamber. For example, a high voltage direct current system includes several sub-modules that reach heights of up to 10 meters and are stacked in several levels. A worker would enter the valve chamber for maintenance, at which time it is necessary to discharge the capacitors of the sub-modules beforehand, for the safety of the worker. In particular, since the plurality of sub-modules is connected in series, as is inherently the case in a modular multilevel converter, the individual sub-modules must be made to have the same electric potential to allow ready access by the worker, after the capacitors are all discharged and the worker enters the valve chamber to perform maintenance work on the sub-modules.

To this end, a device for grounding the sub-modules by connecting the casing of each sub-module may be used. This would involve connecting the casing of each of the sub-modules to lower the electric potential, but there would be an increase in the number of parts, and the grounding devices would get in the way when removing the sub-modules for maintenance purposes, etc.

Moreover, the grounding devices carry the drawbacks of lowered stability, as the installing and detaching of the grounding devices must be performed manually by a worker for each individual device, and lowered workability, as the grounding devices must be reinstalled every time before and after grounding.

### DISCLOSURE

### Technical Problem

Accordingly, the present invention has been made keeping in mind the above problems occurring in the prior art, and an objective of the present invention is to enable a simultaneous grounding connection of the casings of multiple sub-modules by simultaneously connecting the casing of each of the sub-modules with a manipulation on a shorting device.

### Technical Solution

To achieve the objective above, an aspect of the present invention provides a shorting device for grounding a converter composed of a plurality of serially connected sub-modules, where the shorting device includes: a moving rod installed on a main frame, on which the plurality of sub-modules is installed, the moving rod configured to move along a direction traversing the plurality of sub-modules; a plurality of contactors arranged on the moving rod along a lengthwise direction and configured to be electrically connected with the respective casings of the sub-modules according to a movement of the moving rod; and a connection means configured to electrically connect the contactor with another sub-module casing that is adjacent to the sub-module casing to which the contactor is electrically connected.

The connection means is formed with a cable, where one end of the cable is connected with the contactor to move together with the movement of the moving rod, and the other end of the cable is secured to another sub-module adjacent to the sub-module casing to which the contactor is electrically connected.

The sub-module casing is installed on a module support part provided on the main frame, a shorting holder is provided on the module support part to guide the moving rod, and the connection means has either one of the two ends secured to the shorting holder to be electrically connected with the sub-module casing by way of the shorting holder.

An elastic element of which one end contacts the contactor is provided on the moving rod, and the elastic element provides an elastic force on the contactor in the direction of the shorting holder.

A movement section is formed on the moving rod, the contactor is installed to be capable of linear movement within the movement section, and the elastic element has one end connected to the contactor and the other end secured to one side of the movement section so as to elastically support the contactor in the direction of the shorting holder while contacting the shorting holder during a movement of the moving rod, when the contactor is pushed and moved within the movement section in an opposite direction of the movement direction of the moving rod.

A drive assembly configured to enable the movement of the moving rod is connected to one end of the moving rod, where the drive assembly includes a drive source, and a link part configured to convert the rotational force of the drive source into a linear motion of the moving rod.

The link part includes: a first link arm that is connected to the drive source and configured to rotate; a second link arm having one end rotatably connected to the first link arm and having the other end secured to a rotational post to rotate together with the rotational post; and a drive arm having one end secured to the rotational post to rotate together and having the other end rotatably connected to one end of the moving rod to move the moving rod in a linear oscillating movement.

The main frame includes mount frames provided in a plurality of levels at different heights, a plurality of sub-module casings is installed on the mount frame of each level, and the moving rod and the connection means are installed on a module support part of the mount frame.

A plurality of drive arms is installed on the rotational post, where the plurality of drive arms is installed at heights corresponding to the plurality of mount frames to operate the moving rods provided on the respective mount frames.

The main frame includes a roller configured to guide the movement of the moving rod.

The connection means connects the contactor with another contactor connected to another sub-module casing that is adjacent to the sub-module casing to which the contactor is electrically connected.

The connection means is a conductor part of the moving rod.

### Advantageous Effects

A shorting device for the grounding of a converter according to the present invention provides the following effects.

With the present invention, multiple sub-modules may be grounded simultaneously in a simple manner with a manipulation of the shorting device by providing simultaneous connections between the casings of the sub-modules forming the converter, thereby improving the stability of the work area as well as reducing the time required for lowering the electric potentials of the sub-modules for an increased work speed.

In particular, with the present invention, the shorting device may be installed under the frame of the converter, and a moving rod forming a part of the device may concurrently short-circuit and ground the casings of the sub-modules. Since there is no interference between the shorting device and the sub-modules when separating a sub-module for maintenance, there is no need to separate the shorting device each time, and the maintenance of the converter is improved.

Also, with the present invention, an elastic element is used to elastically support the contactor, which forms a part of the shorting device, in the direction of the shorting holder, so that a reliable electrical connection may be formed between the two, and even if a certain degree of plastic deformation occurs from repeated contact between the contactor and the shorting holder, the elastic element may ensure electrical connection is achieved.

Also, with the present invention, since the converter is formed across a plurality of levels, and since the moving rod and contactor provided at each level are operated simultaneously by a single drive source, all of the sub-modules can be grounded with a relatively small number of parts, and as the shorting device is installed under the frame, the worker may readily check the device by sight.

Also, with the present invention, it is possible to manipulate the drive source of the shorting and grounding device from a location remote from the work area. Thus, the worker need not manipulate the shorting and grounding device from within the valve chamber, and the stability and convenience of the work may be further improved.

### DESCRIPTION OF DRAWINGS

FIG. 1 is a perspective view illustrating the composition of a converter to which a device for grounding a converter according to an embodiment of the present invention is applied.

FIG. 2 is a perspective view with the sub-modules removed from FIG. 1.

FIG. 3 is a perspective view illustrating the composition of a drive source and a link part in an embodiment of the present invention.

FIG. 4 is a side-elevational view illustrating the casings of sub-modules connected by contactors according to an embodiment of the present invention.

FIG. 5 is a side-elevational view illustrating the connections between the casings of sub-modules disengaged by a movement of the moving rod and the contactors according to an embodiment of the present invention.

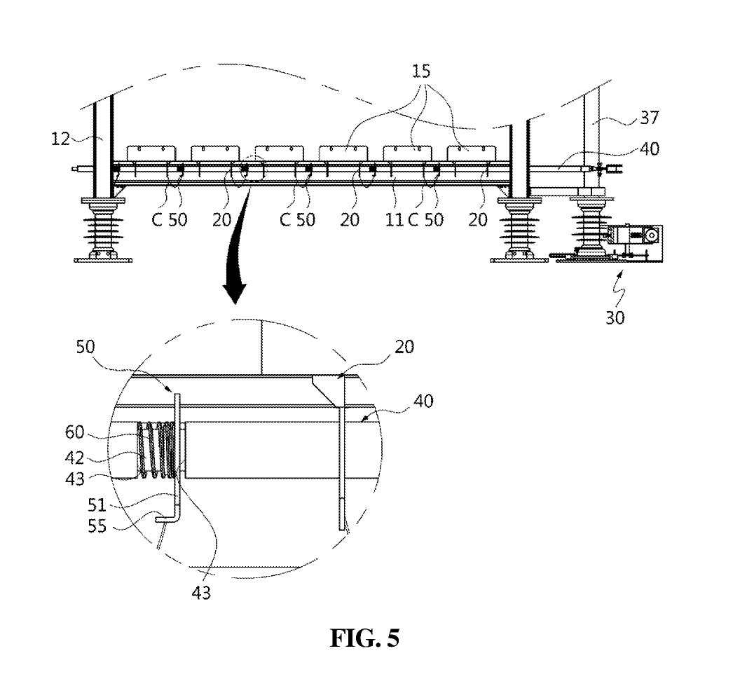

FIG. 6 is a perspective view illustrating the composition of a contactor, a ground holder, and an elastic element according to an embodiment of the present invention.

FIG. 7 and FIG. 8 are perspective views illustrating the casing of each sub-module in a grounded state and a non-grounded state resulting from the movement of the moving rod according to an embodiment of the present invention.

FIG. 9 is a side-elevational view illustrating the composition of a converter to which a device for grounding a converter according to another embodiment of the present invention is applied.

FIG. 10 is a side-elevational view illustrating the composition of a converter to which a device for grounding a converter according to yet another embodiment of the present invention is applied.

### MODE FOR INVENTION

A detailed description of certain embodiments of the present invention is provided below with reference to illustrative drawings. It should be noted that, in adding reference numerals to the components shown in the drawings, the same numerals are applied for the same components as often as possible even when shown in different drawings. Also, in describing the embodiments of the present invention, specific descriptions of related prior art or functions are omitted, if it is deemed that such descriptions may impede the understanding of the embodiments of the present invention.

In describing the components of the embodiments of the present invention, terms such as first, second, A, B, (a), (b), etc. may be used. Such terms are intended merely to differentiate a component from another component and do not limit the quality, sequence, or order of the component. A mention of a component being “connected”, “coupled”, or “joined” to another component should be understood as meaning that, while the component may be directly connected or joined to the other component, one or more other components may be “connected”, “coupled”, or “joined” in-between.

In the descriptions below, a high voltage direct current (HVDC) system is used as an example of a converter device.

For convenience, the sub-modules S forming the converter device are first considered. A plurality of sub-modules S is included, with each sub-module S mainly composed of a power part 2 and a capacitor part 3. The power part 2 is the part where various power-related semiconductors and various boards are installed.

The outer portions of the capacitor part 3 and the power part 2 are installed onto a sub-module casing 1, and although it is not shown in the drawings, a cathode terminal of the capacitor part 3 is connected to the casing 1 to enable the grounding of the sub-module S. Of course, since the plurality of sub-module casings 1 is spaced apart from one another, the grounding requires grounding each of the sub-module casings 1 or connecting the casings for simultaneous grounding. A shorting device based on the present invention connects the sub-module casings 1 together for grounding.

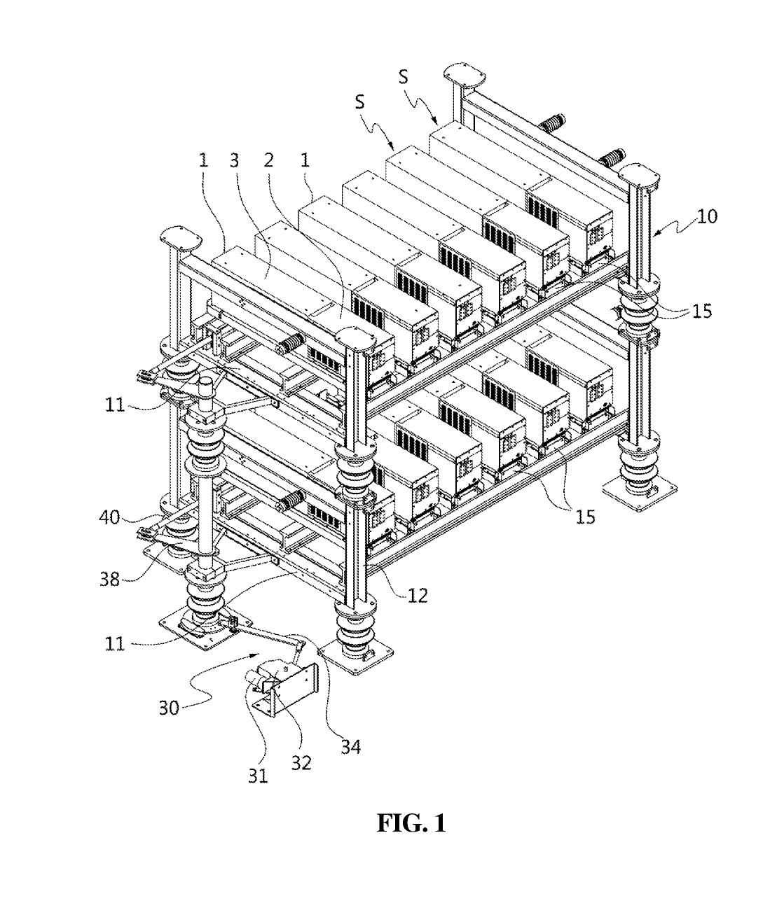

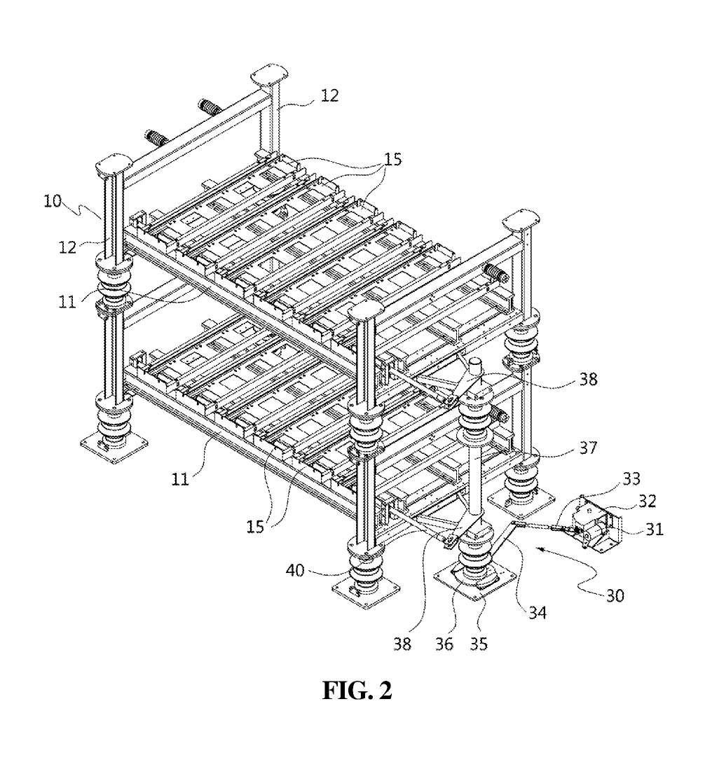

The sub-module casing 1 is installed onto the main frame 10 of the converter, where the main frame 10 includes mount frames 11 that are formed in multiple levels and vertical frames 12 that interconnect the mount frames 11. As shown in FIGS. 1 and 2, with the present invention, the main frame 10 is formed with two levels, and a total of six sub-modules S are installed on each level. Of course, it is possible to have the main frame 10 formed with one level or with three or more levels. While it is not shown in the drawings, the vertical frames 12 may be provided with insulation.

As shown in FIG. 2, a plurality of module support parts 15 is provided on the mount frame 11. The module support part 15 is positioned under each sub-module S, having the sub-module S placed thereon. The module support part 15 is one of the parts that connect with the sub-module casing 1 to allow the grounding of the sub-module S. In this embodiment, the module support parts 15 are installed in a direction traversing the mount frames 11. While it is not shown in the drawings, any one of the module support parts 15 may extend outwards and be grounded.

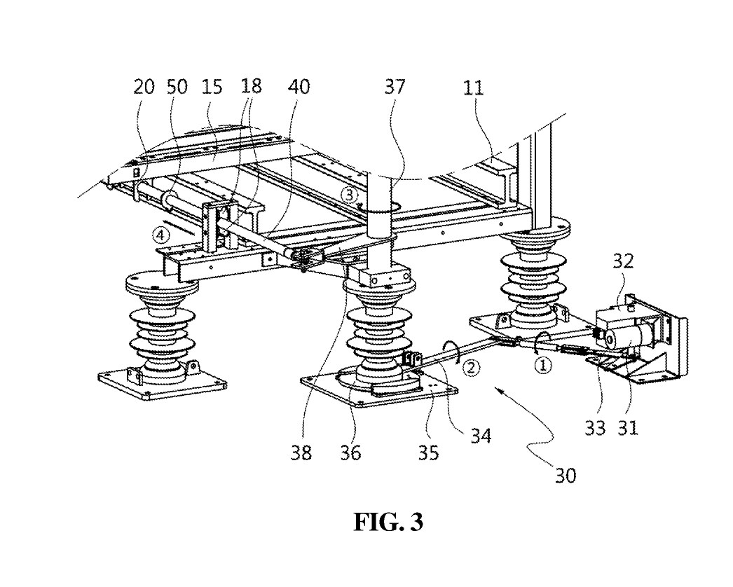

As shown in FIG. 3, rollers 18 are provided at one side of the mount frame 11. The rollers 18 are installed on the movement path of the moving rod 40, described later on, to facilitate the movement of the moving rod 40, and may be regarded as a sort of bearing. The rollers 18 may be provided on both sides of the mount frame 11 to support both sides of the moving rod 40.

At a lower portion of the module support part 15, a shorting holder 20 is provided. The shorting holder 20 is provided protruding down from the module support part 15 and serves to support the moving rod 40 in a suspended form. Also, the shorting holder 20 contacts the contactor 50, described later on, thereby serving also to electrically connect two adjacent sub-module casings 1.

One shorting holder 20 or a pair of shorting holders 20 are provided at the lower portion of the module support part 15. The one shorting holder 20 or pair of shorting holders 20 are configured to be electrically connected by way of the module support part 15. Either one of the pair of shorting holders 20 is selectively connected with the contactor 50, while the other shorting holder 20 or contact part is connected with one end of the connection means C, which will be described later on. Here, the connection means C is connected from a contactor 50 positioned at a different adjacent module support part 15.

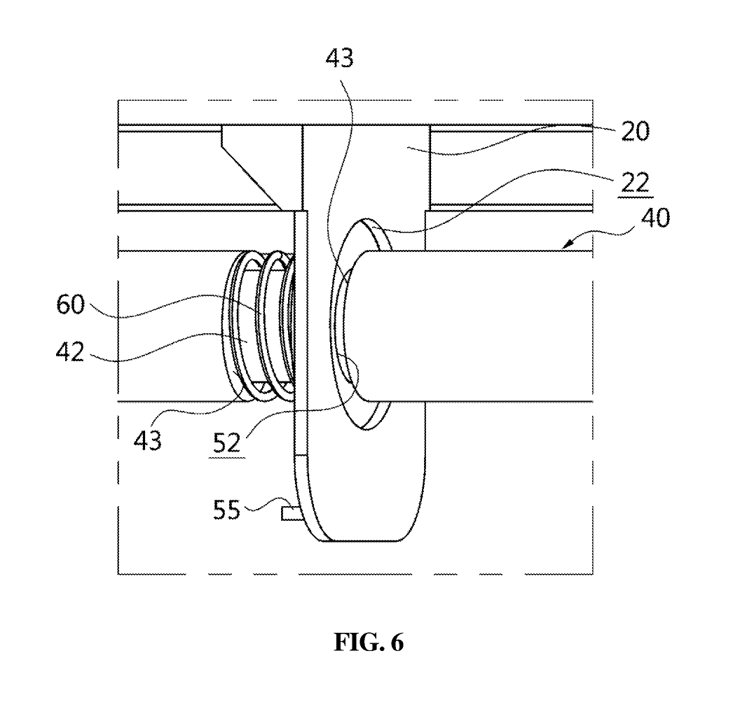

Referring to FIG. 6, a through hole 22 is formed in the shorting holder 20, and the moving rod 40 may pass through the through hole 22. That is, the shorting holder 20 supports the moving rod 40 such that the moving rod 40 is movable through the through hole 22. As shown in FIG. 6, while the present embodiment has the bottom of the through hole 22 closed off, it is possible to have the bottom of the through hole 22 open.

At one side of the main frame 10, a drive assembly 30 is provided. The drive assembly 30 is for operating the insulating device according to the present invention and includes a drive source 31 and a link part. The drive source 31 may be implemented with an electric motor, for example, to provide a rotational force, and in this case, a worker may manipulate the device by turning the drive source 31 on/off without having to personally operate the moving rod 40 of the insulating device. Of course, it is possible to install the control part for manipulating the drive source 31 at a remote location, and it is also possible to provide a separate maintenance system to operate the drive source 31 automatically according to a manual.

The link part is connected to the drive source 31. The link part is composed of a plurality of rotatable parts that operate in linkage with one another, to ultimately convert their rotational motion into a linear oscillating motion of the moving rod 40. The link part is rotated by the drive source 31 in an oscillating movement within a certain section, and in the process operates the moving rod 40 to either short-circuit and ground all of the sub-module casings 1 or disengage the short circuit so that the sub-module casings 1 are no longer grounded and have individual electric potentials.

The link part includes a first link arm 33, which is connected to the drive source 31 and rotated, and a second link arm 34, which is connected to the first link arm 33. The second link arm 34 has one end rotatably connected to the first link arm 33 and the other end secured to the rotational post 37, so as to rotate the rotational post 37. Reference numeral 32 represents a drive device that is connected to the drive source 31 to transfer the rotational force to the link part and may be a control device such as a reducer.

The rotational post 37 extends from the ground in a perpendicular direction, as do the vertical frames 12, and has one end 36 rotatably supported on a support plate 35 placed underneath to be capable of rotation. The second link arm 34 is installed on the rotational post 37, so that the first link arm 33 and the second link arm 34 rotate in linkage.

On the rotational post 37, a drive arm 38 is installed to rotate together. The drive arm 38 is secured to the outer surface of the rotational post 37, while the protruding end is rotatably connected to the moving rod 40. Accordingly, as the rotational post 37 is rotated, the drive arm 38 pushes or pulls the moving rod 40 to cause linear motions. Of course, it is also possible to omit such link part and operate the moving rod 40 by connecting a device for providing linear oscillation motion, such as a pneumatic cylinder, directly onto the moving rod 40.

Here, a plurality of drive arms 38 is installed on the rotational post 37 at heights corresponding to the plurality of mount frames 11 or, to be more precise, corresponding to the module support parts 15 installed on the mount frames 11. Thus, the plurality of drive arms 38 can operate the moving rods 40 provided on the respective shorting holders 20 of the module support parts 15. That is, as one rotational post 37 is rotated, the plurality of sub-module casings 1 installed respectively on the mount frames 11 of a plurality of levels may be electrically interconnected and thus be grounded.

Next, a description of the moving rod 40 is provided. The moving rod 40 is movably installed on the main frame 10 where the plurality of sub-modules S is installed and, to be more precise, is supported by the plurality of shorting holders 20 installed on the module support parts 15 of the main frame 10. That is, the moving rod 40 is able to move along a direction traversing the plurality of sub-modules S and move the contactors 50 in the process. One end of the moving rod 40 is connected to the drive arm 38, to be moved linearly by the rotation of the drive arm 38.

Here, the moving rod 40, by its movement, causes the contactors 50 to contact or be separated from the shorting holders 20, and is made from an insulating material or at least is covered with an insulator on its outer surface, so that the moving rod 40 itself does not perform an electrical connection.

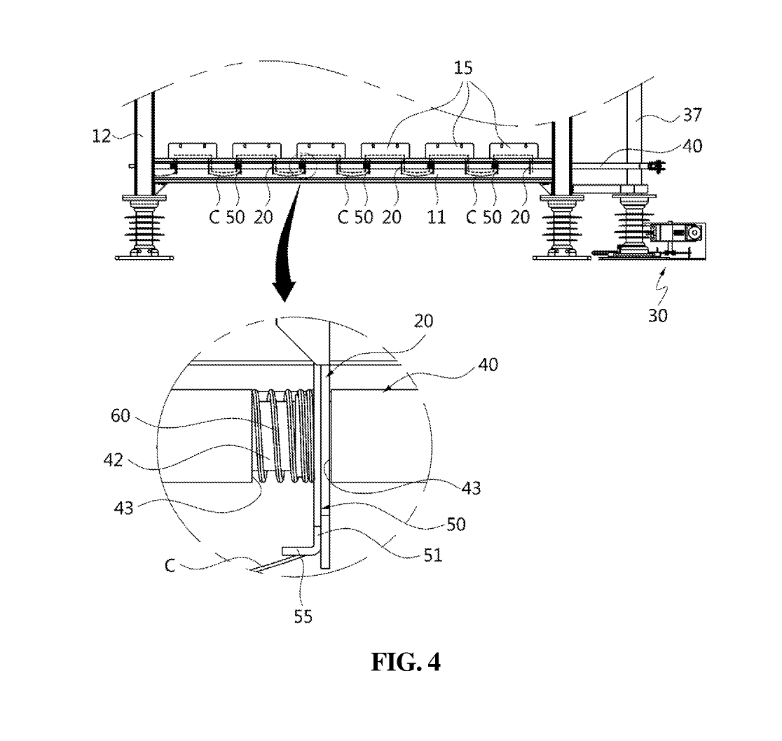

As shown in the magnified portion of FIG. 4, movement sections 42 are formed on the moving rod 40. The movement sections 42 are portions of the moving rod 40 in which the diameter is formed smaller to form indentations, and the contactors 50 may be movably installed in such movement sections 42. Reference numeral 43 represents the step formed at both ends of a movement section 42. Also, within the movement section 42, an elastic element 60 is installed to elastically support the contactor 50. Of course, instead of forming the movement section 42 as a section of reduced diameter, it is also possible to form the movement section 42 as a section between two points that protrude from the outer surface of the moving rod 40.

The contactors 50 are installed on the moving rod 40. The contactors 50 selectively contact and thus electrically connect the shorting holders 20, thereby providing connections between the sub-module casings 1 that are separated from each other. The contactors 50 move together with the moving rod 40 and in this embodiment has the shape of a disk. Of course, the shapes of the contactors 50 may vary.

As illustrated in FIGS. 4 and 6, a contactor 50 has a disk-shaped contact body 51 configured to contact a shorting holder 20, while at a lower portion of the contact body 51 a connector part 55 is provided, onto which one end of the connection means C, described later on, is secured. A connection hole 52 is formed in the contact body 51, and by having the movement section 42 pass through the connection hole 52, the contactor 50 may be installed to be movable within the movement section 42 of the moving rod 40. That is, the contactor 50 for the main part moves linearly together with the moving rod 40, but within the movement section 42, is able to move independently of the moving rod 40. This is to enable a tighter contact between the contactor 50 and the shorting holder 20.

With reference to FIG. 4, as the moving rod 40 moves towards the right, the contactors 50 contact the shorting holders 20, and while in this state, if the moving rod 40 continues to move further in the same direction, the contactors 50 may be pushed within the movement section 42 in a direction opposite the movement direction of the moving rod 40, i.e. pushed towards the left. Here, the elastic elements 60 are compressed and elastically support the contactors 50 by strongly pushing the contactors 50 in the direction of the shorting holders 20 (towards the right in the drawing). As a result, the contacting forces between the contactors 50 and the shorting holders 20 are increased, allowing more stable connections and reliably ensuring close contact and electrical connection between the contactors 50 and shorting holders 20 even if there is a certain degree of plastic deformation caused by repeated use or if there are manufacturing errors.

Between a contactor 50 and an adjacent shorting holder 20 is provided a connection means C. The connection means C is for electrically connecting the contactor 50 with the shorting holder 20 and in this embodiment is formed as a cable. To be more precise, the connection means C provides an electrical connection between a contactor 50 and another sub-module casing 1 adjacent to the sub-module casing 1 to which the contactor 50 is electrically connected.

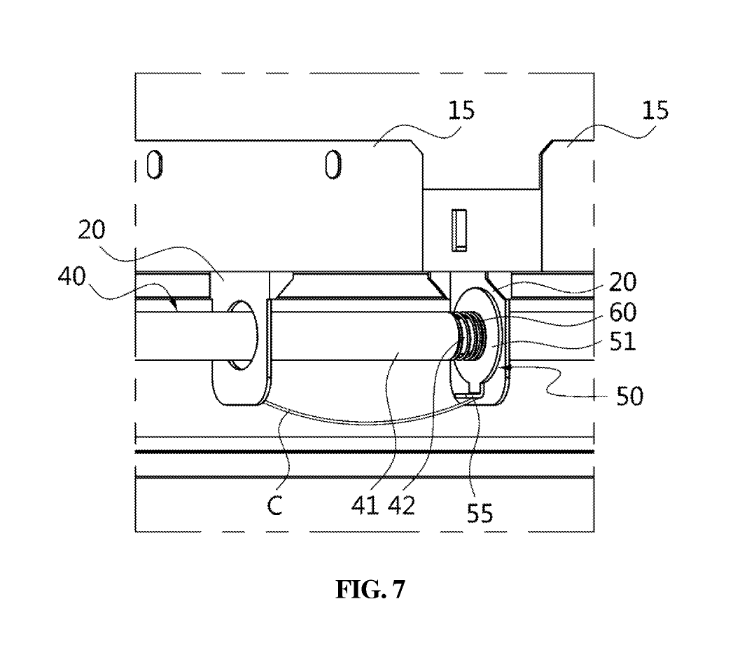

As shown in FIG. 7, the connection means C has one end connected with the contactor 50, while the other end is connected, not with the shorting holder 20 that is contacted by the contactor 50, but with another adjacent shorting holder 20, to be more precise, another shorting holder 20 that is installed on the neighboring module support part 15 (the module support part positioned on the left in the drawing). As a result, the two module support parts 15 that are spaced apart from each other may be electrically connected by the connection means C. Of course, such electrical connection occurs when the contactor 50 has contacted the shorting holder 20. The dotted lines in FIG. 4 show how several neighboring module support parts 15 are connected in a continuous manner by way of the connection means C, contactors 50, and shorting holders 20.

Although the present embodiment is illustrated with the connection means C exposed to the exterior, the connection means C may be installed on the inside of the moving rod 40 so as not to be exposed to the exterior. Incidentally, while the drawing is illustrated with the other end of the connection means C being connected to a lower portion of the shorting holder 20, the connection means C may be secured to an arbitrary contact part other than the shorting holder 20. Here, the arbitrary contact part may be implemented as a portion of the shorting holder 20 or a portion of the module support part 15 or a connection terminal provided on such components.

Below, a description is provided of the operating process of a shorting device for the grounding of a converter based on the present invention, with reference to the relevant drawings.

Supposing an example in which a worker enters a valve chamber in which a converter device is installed for maintenance of the sub-modules S, the converter device should first be stopped for safety, the sub-modules S should be shorted, and the electric potentials should be lowered by grounding with a line connected to an arbitrary contact part or shorting circuit.

When the drive source 31 of the shorting device is operated for this purpose, the drive source 31 operates and rotates the link part. Here, the operation of the drive source 31 may be manipulated from a location that is remote from the valve chamber and may be performed automatically according to a manual built into the system.

Referring to FIG. 3, the operation of the link part follows procedures below. First, when the first link arm 33 is rotated by the drive source 31, the second link arm 34 connected thereto is rotated, and the second link arm 34 rotates the rotational post 37. During this process, the drive arm 38 installed on the rotational post 37 rotates together and pushes the one end of the moving rod 40 for a linear movement of the moving rod 40. Incidentally, FIG. 3 illustrates the shorting device in a closed state, where moving the first link arm 33, second link arm 34, drive arm 38, and moving rod 40 in the directions of arrows T-C) would result in an open state.

When the moving rod 40 moves, the contactors 50 installed on the moving rod 40 move together and are pressed against the shorting holders 20. The shorting holders 20 are installed secured to lower portions of the module support parts 15, where the sub-module casings 1 are installed, and are selectively contacted by the contactors 50 by the movement of the moving rod 40. Considering the process by which a contactor 50 is pressed against the shorting holder 20, as the moving rod 40 is moved, the contactor 50 first comes into contact with the shorting holder 20, and when the moving rod 40 continues to move further from this state, the contactor 50 is pushed in a direction opposite the movement direction of the moving rod 40 while within the movement section 42 of the moving rod 40. This is because, while the contactor 50 moves together with the moving rod 40, the contactor 50 may move independently to the moving rod 40 while in the movement section 42.

Here, as the contactor 50 is pushed, the elastic element 60 is compressed, and the contactor 50 is strongly pushed in the direction of the shorting holder 20 and elastically supported by the elastic force of the elastic element 60. Accordingly, the contacting force between the contactor 50 and the shorting holder 20 is further increased for a stable connection, and even if there is a certain degree of plastic deformation resulting from repeated use or if there are manufacturing errors, a firm contact between the contactor 50 and the shorting holder 20 and the resulting electrical connection therebetween may be ensured.

A plurality of contactors 50 is provided on the moving rod 40, and each contactor 50 is placed in tight contact with a respective shorting holder 20. Also, an operation such as the above is performed simultaneously for each of the sub-module casings 1 on different levels, as each of the plurality of drive arms 38 installed on the rotational post 37 operates a moving rod 40.

The contactors 50 and the shorting holders 20 are electrically connected by way of the connection means C. Here, the shorting holder 20 connected with the connection means C is not the shorting holder 20 that the contactor 50 has contacted, but rather a different adjacent shorting holder 20, to be more precise, the shorting holder 20 installed on another module support part 15 neighboring the module support part 15 on which is installed the shorting holder 20 that the contactor 50 has contacted. Consequently, the two neighboring module support parts 15 are electrically connected. That is, as shown in FIG. 4, an electrical connection is achieved in the sequence of (i) a shorting holder 20, (ii) a contactor 50 that has contacted the shorting holder 20, (iii) a connection means C having one end connected to the contactor 50, and (iv) a different, neighboring shorting holder 20 connected to the other end of the connection means C. Since this structure is continued along the lengthwise direction of the moving rod 40, all of the sub-module casings 1 located on the same level are connected and are short-circuited together to allow a common grounding. That is, the grounding structures of a plurality of sub-module casings 1 are put in a closed state, are connected to a ground, and thus have the electric potentials lowered overall, to be safe for approaching.

In this state, a worker may enter the valve chamber to separate and maintain a sub-module S, and since with the present invention the shorting holders 20, the moving rod 40 secured thereto, etc. are all positioned under the main frame 10 or, to be more precise under the module support parts 15, the components do not interfere with the separating or installing of the sub-modules S. Therefore, the worker may readily perform maintenance of the sub-modules S and operate the converter device after leaving the valve chamber and putting the grounding device and shorting device in an open state again.

The opening of the shorting device proceeds in a direction opposite the operating direction of the drive assembly 30 described above, where the operating direction is represented by arrows in FIG. 3.

As set forth above, the present invention may utilize a shorting device to simultaneously ground or disengage from a grounded state a plurality of sub-module casings 1. Excluding the case of maintaining the shorting device itself, the shorting device may be used continuously in its initially installed state regardless of the maintenance of the sub-modules S. Also, since the shorting holders 20, the moving rod 40 secured thereto, etc. are all positioned under the module support part 15, the worker may readily observe the components by sight and check their status.

In the foregoing, even though the components included an embodiment of the present invention are described as being coupled into an integrated form or as operating in a coupled manner, the present invention is not limited to such embodiment. That is, the components may be coupled selectively for operation without departing from the purpose of the present invention. Also, a description using a term such as “comprising”, “including”, “having”, etc. regarding a particular component merely means that the corresponding component is present, and therefore, the description should not be interpreted as precluding the presence of other components but rather should be interpreted as allowing for the inclusion of other components unless there is a specific statement to the contrary. All terms used herein, including technical and scientific terms, are of the same meaning as those understood by a person having ordinary skill in the field of art to which the present invention pertains, unless defined otherwise. Generally used terms, such as those defined in the dictionary, are to be interpreted in agreement with the context of the relevant technology and, unless clearly defined with respect to the present invention, are not to be interpreted as having ideal or overly formal meanings.

The descriptions above are merely illustrative of the technical spirit of the present invention, and the person having ordinary skill in the field of art to which the present invention pertains would be able to derive various modifications and alterations without departing from the fundamental essence of the present invention. Thus, the embodiments of the present invention are disclosed, not to limit, but to explain the spirit of the present invention, and the scope of the technical sprit the present invention is not to be limited by the embodiments. The scope of protection of the present invention is to be interpreted from the scope of claims below, and all technical concepts within the scope of equivalency are to be regarded as being encompassed by the scope of rights of the present invention.

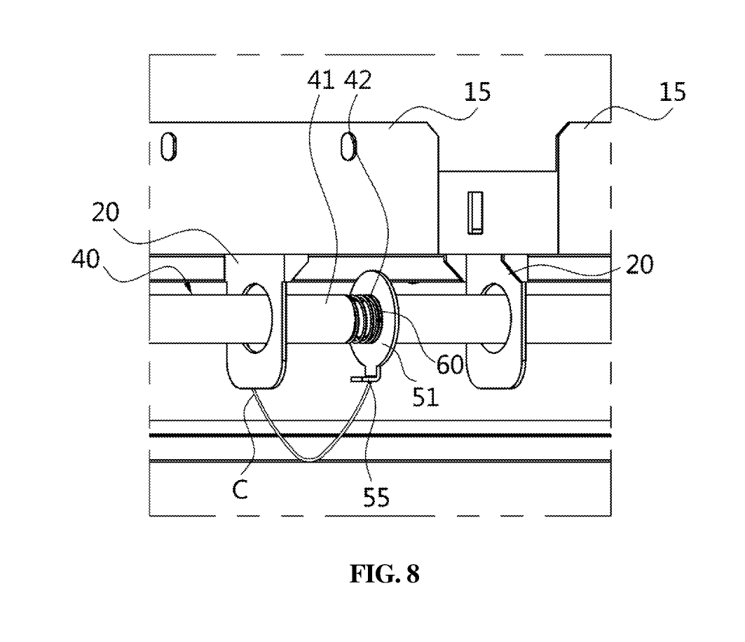

For example, it is possible to have a cable acting as the connection means C, instead of connecting the contactor 50 with the shorting holder 20 installed on another neighboring module support part 15, connecting two neighboring contactors 50 directly as shown in FIG. 9 or connecting to another contact terminal on the neighboring module support part 15. In this way, an electrical connection may be attained between two neighboring sub-module casings 1. In this case, just one shorting holder 20 may be provided on each module support part 15.

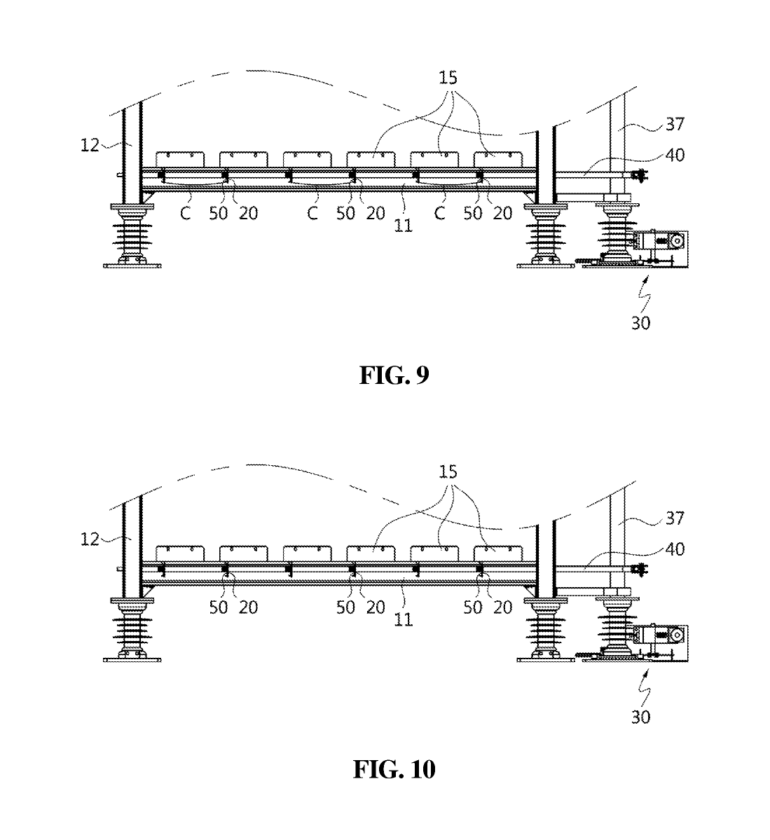

Also, while the embodiment described above has the connection means C implemented by a cable, it is possible to have the connection means C implemented by the moving rod 40 itself, as shown in FIG. 10. For example, the moving rod 40 may have the outer surface insulated by an insulator but may provide a connection between the contactor 50 and the neighboring shorting holder 20 by using a conductor part formed inside.

In this case, the device may include just one shorting holder 20 provided for each module support part 15 and the contactor 50 structured to contact a respective shorting holder 20. Also, each contactor 50 may be electrically connected by way of the conductor part formed on the inside of the insulator of the moving rod 40 for a common grounding.

1. A shorting device for a grounding of a converter comprising a plurality of serially connected sub-modules, the shorting device comprising:
a moving rod installed on a main frame, the main frame having the plurality of sub-modules installed thereon, the moving rod configured to move along a direction traversing the plurality of sub-modules;
a plurality of contactors arranged on the moving rod along a lengthwise direction and configured to be electrically connected with casings of the respective sub-modules according to a movement of the moving rod; and
a connection means configured to electrically connect the contactor with another sub-module casing adjacent to the sub-module casing having the contactor electrically connected thereto.

2. The shorting device for a grounding of a converter according to claim 1, wherein the connection means is formed with a cable, the cable having one end thereof connected with the contactor to move together with the movement of the moving rod, the cable having the other end thereof secured to another sub-module adjacent to the sub-module casing having the contactor electrically connected thereto.

3. The shorting device for a grounding of a converter according to claim 1, wherein the sub-module casing is installed on a module support part provided on the main frame, the module support part has a shorting holder provided thereon for guiding the moving rod, and the connection means has either one end thereof secured to the shorting holder or an arbitrary contact part to be electrically connected with the sub-module casing by way of the shorting holder.

4. The shorting device for a grounding of a converter according to claim 1, wherein the moving rod has an elastic element provided thereon, the elastic element has one end thereof contacting the contactor, and the elastic element provides an elastic force on the contactor in a direction of the shorting holder.

5. The shorting device for a grounding of a converter according to claim 4, wherein the moving rod has a movement section formed thereon, the contactor is installed to be capable of linear movement within the movement section, the elastic element has one end thereof connected to the contactor and the other end thereof secured to one side of the movement section so as to elastically support the contactor in the direction of the shorting holder while contacting the shorting holder during a movement of the moving rod when the contactor is pushed and moved within the movement section in an opposite direction of the movement direction of the moving rod.

6. The shorting device for a grounding of a converter according to claim 1, wherein a drive assembly is connected to one end of the moving rod, the drive assembly configured to enable a movement of the moving rod, the drive assembly comprising:
a drive source; and
a link part configured to convert a rotational force of the drive source into a linear motion of the moving rod.

7. The shorting device for a grounding of a converter according to claim 6, wherein the link part comprises:
a first link arm connected to the drive source and configured to rotate;
a second link arm having one end thereof rotatably connected to the first link arm and having the other end thereof secured to a rotational post to rotate together with the rotational post; and
a drive arm having one end thereof secured to the rotational post to rotate together and having the other end thereof rotatably connected to one end of the moving rod to move the moving rod in a linear oscillating movement.

8. The shorting device for a grounding of a converter according to claim 7, wherein the main frame includes mount frames provided in a plurality of levels at different heights, a plurality of sub-module casings is installed on a mount frame of each level, and the moving rod and the connection means are installed on a module support part of the mount frame.

9. The shorting device for a grounding of a converter according to claim 8, wherein the rotational post has a plurality of drive arms installed thereon, the plurality of drive arms installed at heights corresponding to the plurality of mount frames to operate the moving rods provided on the respective mount frames.

10. The shorting device for a grounding of a converter according to claim 1, wherein the main frame includes a roller configured to guide the movement of the moving rod.

11. The shorting device for a grounding of a converter according to claim 1, wherein the connection means connects the contactor with another contactor connected to the another sub-module casing adjacent to the sub-module casing having the contactor electrically connected thereto.

12. The shorting device for a grounding of a converter according to claim 1, wherein the connection means is a conductor part of the moving rod.

13. The shorting device for a grounding of a converter according to claim 3, wherein the moving rod has an elastic element provided thereon, the elastic element has one end thereof contacting the contactor, and the elastic element provides an elastic force on the contactor in a direction of the shorting holder.
